(19) United States
(12) Patent Application Publication
(10) Pub. No.: US 2007/0026833 A1
(43) Pub. Date: Feb. 1, 2007

(54) Method, apparatus and computer program product providing widely linear interference cancellation for multi-carrier systems

(75) Inventor: Kiran Kuchi, Irving, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/496,832

(22) Filed: Jul. 31, 2006

Related U.S. Application Data
(60) Provisional application No. 60/704,758, filed on Aug. 1, 2005.

(51) Int. Cl. H04B 1/10

(52) U.S. Cl. 455/296

(57) ABSTRACT

A method is provided. The method includes: receiving a multi-carrier signal that includes a plurality of subcarriers; and performing widely linear (WL) processing on the received signal.

### CROSS-REFERENCE TO RELATED APPLICATIONS

This patent application claims priority under 35 U.S.C. §119(e) from Provisional Patent Application No. 60/704,758, filed Aug. 1, 2005, the disclosure of which is incorporated by reference herein in its entirety.

### TECHNICAL FIELD

The exemplary and non-limiting embodiments of this invention relate generally to wireless communications systems and, more specifically, relate to multi-carrier communications systems wherein interference cancellation is desirable.

### BACKGROUND

A signal processing application of interest to this invention is one known as “widely linear filtering” (WLF) that uses the complex and complex-conjugate parts of a signal for estimation (or, detection). Recently, WLF concepts have been applied to a number of communication applications, such as equalization, interference suppression and multi-user detection. General reference in this regard may be made to B. Picinbono and P. Chevalier, “Widely linear estimation with complex data,” IEEE Trans. Signal Processing, vol. 43, pp. 2030-2033, August 1995; W. H. Gerstacker, F. Obemosterer, R. Schober, A. Lehmann, A. Lampe, and P. Gunerben, “Equalization concepts for alamoutis space-time block code,” IEEE Trans. Commun., vol. 52, pp. 1178-90, 2004; H. Trigui and D. Slock, “Cochannel interference cancellation within the current gsm standard,” in Proc. Universal Personal Communications, October 1998, pp. 511-15; and D. Darsena, G. Gelli, L. Paura, and F. Verde, “Widely linear equalization and blind channel identification for interference-contaminated multicarrier systems,” IEEE Trans. Signal Processing, vol. 53, pp. 1163-77, 2005.

Unraveling the interference effects that arise between symbols of the same signal (Inter-Symbol Interference or ISI), or among multiple users that share the available spectrum (Co-Channel Interference or CCI), is a major challenge in the design and operation of communication receivers. TDMA receivers handle this problem by using equalization techniques, whereas OFDM alleviates the equalization complexity by processing signals in the frequency domain using the Discrete Fourier Transform (DFT).

Traditionally, multiple antennas are used at the receiver to mitigate interference, a generally complex solution that requires multiple RF branches. Recently, WLF concepts have been promoted as a low cost means to provide equalization using a single receiver antenna. This concept has found wide spread application in GSM systems as Single Antenna Interference Cancellation (SAIC).

Reference with regard to SAIC may be had to commonly-assigned U.S. Patent Publication: US 2005/0266383, G. Mattellini, K. Kuchi, and P. Ranta, “Method and apparatus for suppressing co-channel interference in a receiver”; U.S. Patent Publication: US 2005/0036575, K. Kuchi et al., “Method and apparatus providing low complexity equalization and interference suppression for SAIC GSM/EDGE receiver”; and K. Kuchi and C. Zhang, and U.S. patent application Ser. No. 10/823,196, filed Apr. 12, 2004, “An I/Q MIMO detection framework for single antenna interference cancellation”.

### SUMMARY

A method is provided. The method includes: receiving a multi-carrier signal that includes a plurality of subcarriers; and performing widely linear (WL) processing on the received signal.

A computer program product having program instructions embodied on a tangible computer-readable medium is provided. Execution of the program instructions results in operations including: inputting a received multi-carrier signal that includes a plurality of subcarriers; and performing widely linear (WL) processing on the received signal.

An electronic device is provided. The electronic device includes: a multi-carrier radio frequency receiver having an input for coupling to at least one antenna; a signal processing block coupled to an output of the receiver, wherein the signal processing block includes a widely linear (WL) signal processing unit operable to demodulate a received multi-carrier signal; and a decoder having an input coupled to an output of the signal processing block.

An integrated circuit is provided. The integrated circuit includes: a multi-carrier radio frequency receiver having an input for coupling to at least one antenna; a signal processing block coupled to an output of the receiver, wherein the signal processing block includes a widely linear (WL) signal processing unit operable to demodulate a received multi-carrier signal; and a decoder having an input coupled to an output of the signal processing block.

### BRIEF DESCRIPTION OF THE DRAWINGS

In the attached Drawing Figures:

FIG. 1 depicts a flowchart illustrating one non-limiting example of a method for practicing the exemplary embodiments of this invention;

FIG. 2 shows a MS receiver for use with conjugate symmetric modulation;

FIG. 3 shows a MS receiver for use with PAM/QAM modulation;

FIG. 4 shows a WL receiver for use with conjugate symmetric modulation;

FIG. 5 shows a WL receiver for use with PAM/QAM modulation;

FIG. 6 is a block diagram of an electronic device that is suitable for implementing the exemplary embodiments of this invention.

### DETAILED DESCRIPTION

As employed herein, and without a loss of generality, a WL (widely linear) receiver is considered to be one that processes the complex and complex conjugate parts of received data, while a MS (multi-stream) receiver is one that processes the in-phase (I) and quadrature (Q) parts of a complex received signal. Furthermore, as employed herein, a multi-carrier signal is considered to be a signal comprising a plurality of independently modulated sub-carriers.

The exemplary embodiments of this invention provide a simple and low complexity approach to providing interference cancellation (IC) capability in multi-carrier systems using a single receiver antenna. The exemplary embodiments of this invention provide novel WL OFDM detection capability that applies to both Pulse Amplitude Modulation (PAM) and Quadrature Amplitude Modulation (QAM) alphabets, and retains the quintessential features of OFDM, that is, low complexity DFT-based detection. Although the exemplary embodiments of this invention are particularly useful with regards to systems having a single receiver antenna, application of the invention is not limited thereto and the exemplary embodiments of the invention may be applied to systems having a plurality of receiver antennas.

Furthermore, the exemplary embodiments of this invention provide a method, computer program product, electronic device and integrated circuit in which WL processing is applied or enabled with regards to a received multi-carrier signal. In prior art systems, WL filtering had only been applied to single carrier signals. The exemplary embodiments of this invention disclose how to apply WL filtering to multi-carrier signals, such as those utilized in conjunction with OFDM, as a non-limiting example.

Disclosed herein are WL receivers for at least three categories of OFDM modulation signals: (a) “Real” OFDM signaling formats that are synthesized using conjugate symmetric modulation alphabets in the frequency domain which become “real” in time; (b) PAM constellations that employ “real” modulation alphabets such as Binary Phase Shift Keying (BPSK), or M'ary Amplitude Shift Keying (ASK); and (c) QAM constellations.

An OFDM signal definition is provided below, followed by a description of the exemplary embodiments of the invention.

1. Notation

The following notation is adopted throughout:

Matrices (H) are denoted with upper case boldface letters. Vectors (h) are denoted with lower case bold face letters. Scalar quantities (xₖ) are denoted with non-boldface letters. Matrices H′, H†. and |H| denote transpose, Hermitian conjugate, conjugate and determinant operations, respectively. ⊕ denotes element wise convolution between any two matrices or vectors. h(f) denotes the Discrete Fourier Transform (DFT) of a time domain sequence hₖ. Throughout the ensuing description, complex, complex-conjugate based receiver processing is denoted as WL processing, whereas real (I) and imaginary (Q) based receiver filtering is denoted as MS processing.

2. OFDM Concept

An OFDM transmitter sends information symbols xₗ across multiple orthogonal carriers fₗ=l/N, where N is the total number of carriers within an OFDM symbol epoch T̅. The time domain samples are generated using an IDFT operation as shown in Equation 1A:

$${s}_{k} = {s}^{CP} + \frac{1}{N} {\sum }_{l = 0}^{N - 1} {x}_{l} {ⅇ}^{j2π \frac{k ⅈ}{N}} , \\ l = 0 , 1 , … , N - 1 \qquad ( 1 A )$$

where s^{CP} represents the cyclic prefix (CP) corresponding to the last v samples of sₖ. This makes a portion of the transmitted signal periodic in N. After removing the first v samples, the remaining samples can be represented using circular convolution as shown in Equation 1B:
yₖ=hₖ⊕sₖ+nₖ (1B)

where the respective time domain quantities are periodic in N. In the frequency domain the expression shown in Equation 1C applies:
y(fₖ)=h(fₖ)x(fₖ)+n(fₖ) (1C)

where the frequency domain quantities are the DFT of respective time domain quantities, e.g., as shown in Equation 1D:

$$h ( {f}_{k} ) = {\sum }_{l = 0}^{N - 1} {h}_{l} {ⅇ}^{- j2π {f}_{k} l} , \\ k = 0 , 1 , … , N - 1 \qquad ( 1 D )$$

and where one may use the notation x(fₖ)=xₖ.

3. Conjugate Transmission

Using the fact that the IDFT of a conjugate symmetric sequence is real, one technique to transmit “real” signals is to pair up conjugate symmetric QAM symbols in frequency domain as shown in Equation 1E:
xₗ=x_{N-l} (1E)

where xₗ≅x_{l,I}+jx_{l,Q} and the initial and final samples x₀, x_{N/2} are real. Although the information carrying symbols are “QAM”, this can be considered to be a “real” signaling scheme since the IDFT of a conjugate symmetric sequence is real in the time domain. In this case WL processing can be exploited in two ways: either in the time domain or in the frequency domain. Both cases are treated next.

4. Multiple-Stream Processing

Denote the time domain received signal in baseband form as shown in Equation 1F:
yₖ=hₖ⊕sₖ+nₖ (1F)

Since sₖ is real, one can collect the in-phase (I) and quadrature (Q) parts of the received signal and stack them in vector format as shown in Equation 1G:

$$[ \begin{matrix}ℜ {y}_{k} \\ 𝔍 {y}_{k}\end{matrix} ] = [ \begin{matrix}ℜ {h}_{k} \\ 𝔍 {h}_{k}\end{matrix} ] ⊗ {s}_{k} + [ \begin{matrix}ℜ {n}_{k} \\ 𝔍 {n}_{k}\end{matrix} ] \qquad ( 1 G )$$

which takes a vector form shown in Equation 1H:
\tilde{y}ₖ=\tilde{h}ₖ⊕sₖ+ñₖ (1H)

In the frequency domain Equation 11 applies:
\tilde{y}(fₖ)=\tilde{h}(fₖ)x(fₖ)+ñ(fₖ) (1I)

where all of the elements are complex valued and exhibit conjugate symmetry since the underlying time domain quantities are real. One can combine the information carrying symbols pair [x(fₖ),x*(N−fₖ)] using an un-biased minimum mean-squared error (MMSE) scheme as shown in Equation 1J:

$$z ( {f}_{k} ) = \frac{1}{2} {\tilde{h}}^{†} ( {f}_{k} ) {R}_{\tilde{n} \tilde{n}}^{- 1} ( {f}_{k} ) [ \tilde{y} ( {f}_{k} ) + {\tilde{y}}^{*} ( N - {f}_{k} ) ] \\ for \\ k = 1 , … , \frac{N}{2} - 1 \qquad ( 1 J )$$

where MMSE weights are applied after combing the conjugate symmetric parts. Note, however, that the noise whitening matrix in the first part of the expression shown in Expression 1K plays the main role in suppressing interference.
R_{ññ}⁻¹(fₖ), y̅(fₖ) (1K)

The noise correlation matrix is defined as:
R_{ññ}(f_{f})=E[ñ(fₖ) \tilde{n}*(fₖ)] (1Kb)

where E denotes an expectation operation (e.g. an averaging operation with respect to all the random variables contained in the noise term). The noise correlation can be obtained using a pilot signal.

The IC mechanism is shown below using an illustrative example in the section entitled Interference Limited Case. Bit-wise soft decisions can be calculated directly from the decision variable shown in the second part of Expression 1K using standard soft generation methods.

The capacity of the MS receiver is given by Equation 1L:

$${{C}_{MS }}_{Conj} = \frac{1}{N} {\sum }_{k = 1}^{\frac{N}{2} - 1} ln [ 1 + 2 {\tilde{h}}^{†} ( {f}_{k} ) {R}_{\tilde{n} \tilde{n}}^{- 1} ( {f}_{k} ) \tilde{h} ( {f}_{k} ) ] \qquad ( 1 L )$$

where for the purposes of this description, and not as a limitation, channel capacity is measured under the assumption of perfect channel knowledge at the receiver and no channel knowledge at the transmitter. Note that capacity is achieved when the real modulation symbols xₖ are identical, independent (iid), and Gaussian distributed and noise is modeled as an iid Gaussian process. For large N, one can approximate the discrete capacity term using continuous integration as shown in Equation 1M:

$${C}_{MS Conj} = T {\int }_{0}^{\frac{1}{2 T}} ln [ 1 + 2 {\tilde{h}}^{†} ( f ) {R}_{\tilde{n} \tilde{n}}^{- 1} ( f ) \tilde{h} ( f ) ] ⅆ f \qquad ( 1 M )$$

where T=½W and where 2W is the channel bandwidth.
\tilde{h}†(f)R_{ññ}⁻¹(f)\tilde{h}(f) (1N)

Since Expression 1N is an even function of frequency one may alternatively express the capacity term as Equation 10:

$${C}_{MS Conj} = \frac{T}{2} {\int }_{- \frac{1}{2 T}}^{\frac{1}{2 T}} ln [ 1 + 2 {\tilde{h}}^{†} ( f ) {R}_{\tilde{n} \tilde{n}}^{- 1} ( f ) \tilde{h} ( f ) ] ⅆ f \qquad ( 1 O )$$

5. WL Combining

Since the information symbols are transmitted as conjugate symmetric pairs, one may exploit the conjugate symmetry by applying WL filtering on the complex and complex-conjugate replicas, as shown in Equation 1R:
y̅(fₖ)= h̅(fₖ)x(fₖ)+ n̅(fₖ) (1R)

where the individual terms have the form shown in the elements of Expression 1S:
y̅(fₖ)≅[y(fₖ),y*(N−fₖ)]′, h̅(fₖ)≅[h(fₖ),h*(N−fₖ)]′, n̅(fₖ)≅[n(fₖ),n*(N−fₖ)]′ (1S)

The conjugate symmetric symbol pair [x(fₖ), x*(N−fₖ)] can be combined as shown in Equation 1T:

$$\overline{z} ( {f}_{k} ) = \frac{1}{2} {\overline{h}}^{†} ( {f}_{k} ) {R}_{\tilde{n} \tilde{n}}^{- 1} ( {f}_{k} ) \overline{y} ( {f}_{k} ) \\ for \\ k = 1 , … , \frac{N}{2} - 1 \qquad ( 1 T )$$

where R_{ññ}⁻¹(fₖ) denotes the WL noise correlation matrix and z̅(fₖ) is the scalar decision variable that is used to generate bit wise soft decisions.

The capacity of this WL receiver is given by Equation 1V:

$${C}_{WL Conj} = \frac{1}{N} {\sum }_{k = 1}^{\frac{N}{2} - 1} ln [ 1 + {\overline{h}}^{†} ( {f}_{k} ) {R}_{\tilde{n} \tilde{n}}^{- 1} ( {f}_{k} ) \overline{h} ( {f}_{k} ) ] \qquad ( 1 V )$$

For large N, one may can show that the expression shown in Equation 1W is applicable.

$${C}_{WL Conj} = \frac{T}{2} {\int }_{- \frac{1}{2 T}}^{\frac{1}{2 T}} ln [ 1 + {\overline{h}}^{†} ( f ) {R}_{\tilde{n} \tilde{n}}^{- 1} ( f ) \overline{h} ( f ) ] ⅆ f \qquad ( 1 W )$$

6. Interference Limited Case

An analysis is now made of the interference cancellation capability of the WL detection method in the case of a single co-channel interferer. For this analysis it is useful to use the WL combining method described above. This analysis assumes that the interfering signal has conjugate symmetric modulation and is synchronized to the desired signal. The thermal noise component is assumed to be white and Gaussian. For this model one can represent the interference plus noise component as in Equation 1b:
nₖ=gₖ⊕ŝₖ+wₖ (1b)

where Equation 1c gives the interfering signal and Wk represents thermal noise of variance Nₒ/2 per dimension.

$${\hat{s}}_{k} = {\hat{s}}^{CP} + \frac{1}{N} {\sum }_{l = 0}^{N - 1} {\hat{x}}_{l} {ⅇ}^{j2π \frac{kl}{N}} \qquad ( 1 c )$$

In this case, the frequency domain interference plus noise auto-correlation can be written as shown in Equation 1d:
R_{ññ}(fₖ)= g̅(fₖ) g̅†(fₖ)+N₀I (1d)

where Equation 1e represents interfering channel coefficients:
g̅(fₖ)=[g(fₖ),g_{*}(N−fₖ)]′ (1e)

Using a matrix inversion formula, R_{ññ}(fₖ) can be represented as shown in the expressions denoted by Equations 1g and 1h:

$$\begin{matrix}{R}_{\overline{n} \overline{n}}^{- 1} ( {f}_{k} ) = \frac{[ {N}_{0} + {\overline{g}}^{†} ( {f}_{k} ) \overline{g} ( {f}_{k} ) ] I - \overline{g} ( {f}_{k} ) {\overline{g}}^{†} ( {f}_{k} )}{{N}_{0} [ {N}_{0} + {\overline{g}}^{†} ( {f}_{k} ) \overline{g} ( {f}_{k} ) ]} \\ = \frac{[ {N}_{0} + {\vert \overline{g} ( {f}_{k} ) \vert}^{2} ] I - \overline{g} ( {f}_{k} ) {\overline{g}}^{†} ( {f}_{k} )}{{N}_{0} [ {N}_{0} + {\vert \overline{g} ( {f}_{k} ) \vert}^{2} ]}\end{matrix} \qquad \begin{matrix}\begin{matrix}\begin{matrix}( 1 g ) \\ \end{matrix} \\ ( 1 h )\end{matrix} \\ \end{matrix}$$

Using Equation 1g, the effective signal to noise ratio (SNR) at the output of WL detector can be simplified as depicted in the expressions denoted by Equations 1i and 1j:

$$\begin{matrix}{\overline{h}}^{†} ( {f}_{k} ) {R}_{\overline{n} \overline{n}}^{- 1} ( {f}_{k} ) \overline{h} ( {f}_{k} ) = {{\overline{h}}^{†} ( {f}_{k} ) [ \overline{g} ( {f}_{k} ) {\overline{g}}^{†} ( {f}_{k} ) + {N}_{0} I ]}^{- 1} \overline{h} ( {f}_{k} ) \\ = \frac{{\vert \overline{h} ( {f}_{k} ) \vert}^{2}}{{N}_{0} + {\vert \overline{g} ( {f}_{k} ) \vert}^{2}} + \frac{{\overline{h}}^{†} ( {f}_{k} ) [ {\vert \overline{g} ( {f}_{k} ) \vert}^{2} I - \overline{g} ( {f}_{k} ) {\overline{g}}^{†} ( {f}_{k} ) ] \overline{h} ( {f}_{k} )}{{N}_{0} [ {N}_{0} + {\vert \overline{g} ( {f}_{k} ) \vert}^{2} ]}\end{matrix} \qquad \begin{matrix}\begin{matrix}\begin{matrix}( 1 i ) \\ \end{matrix} \\ ( 1 j )\end{matrix} \\ \end{matrix}$$

where the first term represents the SNR that one would obtain for a non-IC detector, and the second part represents the IC gain. One may further simplify the numerator of the second term in Equation 1j as shown in Equation 1k:
h̅†(fₖ)[| g̅(fₖ)|²I− g̅(fₖ) g̅†(fₖ)] h̅(fₖ)=∥h(fₖ)g*(N−fₖ)−g(fₖ)h*(N−fₖ)∥² (1k)

where with this simplification the SNR term becomes that shown in Equation 1l:

$${\overline{h}}^{†} ( {f}_{k} ) {R}_{\overline{n} \overline{n}}^{- 1} ( {f}_{k} ) \overline{h} ( {f}_{k} ) = \frac{{‖ h ( {f}_{k} ) ‖}^{2} + {‖ h * ( N - {f}_{k} ) ‖}^{2}}{{N}_{0} + {‖ g ( {f}_{k} ) ‖}^{2} + {‖ g * ( N - {f}_{k} ) ‖}^{2}} + \frac{{‖ h ( {f}_{k} ) g * ( N - {f}_{k} ) - g ( {f}_{k} ) h * ( N - {f}_{k} ) ‖}^{2}}{{N}_{0} [ {N}_{0} + {‖ g ( {f}_{k} ) ‖}^{2} + {‖ g * ( N - {f}_{k} ) ‖}^{2} ]} \qquad ( 1 l )$$

In an interference limited situation, that is when the thermal noise level is small compared to the interference level, the output SNR is limited by the second term which drops inversely as 1/Nₒ, which implies a significant increase in the output SNR or IC gain. The IC gain term becomes zero when Equation 1m is satisfied, or, when Equation 1n is satisfied.
∥h*(fₖ)g*(N−fₖ)−g(fₖ)h*(N−fₖ)∥²=0 (1m)

$$\frac{h ( {f}_{k} )}{h * ( N - {f}_{k} )} = \frac{g ( {f}_{k} )}{g * ( N - {f}_{k} )} \qquad ( 1 n )$$

It can be noted that this condition rarely occurs for complex valued wireless channels. However, the condition of Equation 1n will always be satisfied in the special case where the signal and interfering channels are modeled as real valued channels; in which case the IC gain diminishes to zero value. One may avoid this pathological situation by applying random (or, deterministic) phase rotations at the transmitter such that the channels always take complex values.

7. MS Processing for PAM OFDM

Consider now an OFDM signal of form shown in Equation 1o:

$${s}_{k} = {s}^{CP} + \frac{1}{N} {\sum }_{l = 0}^{N - 1} {a}_{l} {ⅇ}^{j2π \frac{kl}{N}} \qquad ( 1 o )$$

where the information carrying symbols a₁ belong to a “real” constellation such as a BPSK or a M'ary PAM constellation. Consider then the DFT output shown in Equation 1p:
y(fₖ)=h(fₖ)a(fₖ)+n(fₖ) (1p)

Since a(fₖ) is real, one can collect the in-phase and quadrature parts as shown in Equation 1q:

$$[ \begin{matrix}ℜ y ( {f}_{k} ) \\ 𝔍 y ( {f}_{k} )\end{matrix} ] = [ \begin{matrix}ℜ h ( {f}_{k} ) \\ 𝔍 h ( {f}_{k} )\end{matrix} ] {s}_{k} + [ \begin{matrix}ℜ n ( {f}_{k} ) \\ 𝔍 n ( {f}_{k} )\end{matrix} ] \qquad ( 1 q )$$

In compact vector form this can be represented as shown in Equation 1r:
\check{y}(fₖ)=\check{h}(fₖ)a(fₖ)+\check{n}(fₖ) (1r)

where in this case the linear minimum mean squared error (LMMSE) symbol estimates are given by Equation 1s:
\check{z}(fₖ)=\check{h}†(fₖ)R_{\check{n}\check{n}}⁻¹(fₖ)\check{y}(fₖ) (1s)

The capacity of this scheme for large N can be approximated as shown in Equation 1t:

$${C}_{MS PAM} = \frac{T}{2} {\int }_{- \frac{1}{2 T}}^{\frac{1}{2 T}} ln [ 1 + {\breve{h}}^{†} ( f ) {R}_{\breve{n} \breve{n}}^{- 1} ( f ) \breve{h} ( f ) ] ⅆ f \qquad ( 1 t )$$

This result would be the same if one formulated the WL problem either before or after the DFT using complex and complex-conjugate quantities. While it is preferred to use the MS formulation, since it requires somewhat lower computational power, this is not a limitation upon the practice of the exemplary embodiments of this invention.

8. MS Processing for QAM OFDM

Described now is a WL detection procedure for QAM signals. Consider a QAM modulated OFDM signal format having the form shown in Equation 1w:

$${s}_{k} = {s}^{CP} + \frac{1}{N} {\sum }_{l = 0}^{N - 1} {b}_{I} {ⅇ}^{j2π \frac{kl}{N}} \qquad ( 1 w )$$

where the information carrying symbols bₗ=b_{I,l}+jb_{Q,l} belong to a “complex” constellation, for example to a M'ary PSK or a M'ary QAM constellation. Consider then the frequency domain DFT output shown in Equation 1x:
y(fₖ)=h(fₖ)b(fₖ)+n(fₖ) (1x)

Although a QAM signal is “circular”, i.e., it fully occupies both the in-phase (I) and quadrature (Q) dimensions, one may still benefit from the use of WL filtering in situations where the noise is non-circular. One specific instance of this is when the noise signal contains a PAM signal component. To benefit from the IC gain one may formulate the WL problem using I/Q space. Note in this regard that the WL detection problem can be formulated using complex and complex-conjugate quantities. The I/Q formulation is preferred since it requires somewhat lower computational power, but the I/Q formulation is not to be construed as a limitation upon the practice of the exemplary embodiments of this invention.

One can begin by collecting the I and Q parts of the frequency domain QAM signal as shown in Equation 1y, shown in vector-matrix form in Equation 1z.

$$[ \begin{matrix}{y}_{I} ( {f}_{k} ) \\ {y}_{Q} ( {f}_{k} )\end{matrix} ] = [ \begin{matrix}{h}_{I} ( {f}_{k} ) & - {h}_{Q} ( {f}_{k} ) \\ {h}_{Q} ( {f}_{k} ) & {h}_{I} ( {f}_{k} )\end{matrix} ] [ \begin{matrix}{b}_{I} ( {f}_{k} ) \\ {b}_{Q} ( {f}_{k} )\end{matrix} ] + [ \begin{matrix}{n}_{I} ( {f}_{k} ) \\ {n}_{Q} ( {f}_{k} )\end{matrix} ] \qquad ( 1 y )$$

y(fₖ)=H(fₖ)b(fₖ)+n(fₖ) (1z)

The QAM symbols may be recovered using a ML/MAP decoder that minimizes the distance term shown in Equation 1aa:
d(fₖ)=e(fₖ)Rₙₙ⁻¹(fₖ)e(fₖ) (1aa)

Equation 1ab is the candidate symbol.
e(fₖ)=y(fₖ)−H(fₖ)\hat{b}(fk) (1ab)
|\hat{b}(fₖ) (1bb)

If needed, bit-wise soft decisions can be calculated during this minimization procedure as well. The capacity C_{MS QAM} of this approach is given by Equation 1ac:

$${C}_{MS QAM} = \frac{T}{2} {\int }_{- \frac{1}{2 T}}^{\frac{1}{2 T}} ln det [ I + {\underline{H}}^{†} ( f ) {R}_{\underline{nn}}^{- 1} ( f ) \underline{H} ( f ) ] ⅆ f \qquad ( 1 ac )$$

It can be noted that the capacity when the complex modulation alphabets are circular, iid Gaussian and noise is modeled as an iid Gaussian process. In the special case when the noise is composed of a singe PAM interferer plus thermal noise, that is, when the noise level is small compared to interference level, it can be shown that the capacity term can be approximated as shown in Equation 1ad, which implies a significant reduction in the interference level.

$${C}_{WL QAM} \sim {\int }_{- \frac{1}{2}}^{\frac{1}{2}} ln \frac{S ( {f}_{b} )}{{N}_{0}} ⅆ f \qquad ( 1 ad )$$

It can be noted as well that a conventional QAM detector cannot offer a similar advantage under the same conditions.

One may observe that QAM detection requires an unconventional symbol detection metric, which is not the case with PAM, where the I/Q split creates two independent signal branches which are treated as virtual diversity branches for signal combining. The small increase in complexity results in significant IC gain when the receiver operates in a “non-circular” interference environment.

9. Figures

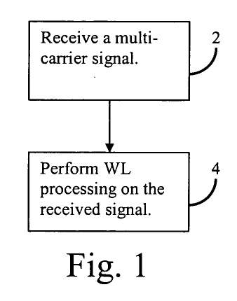

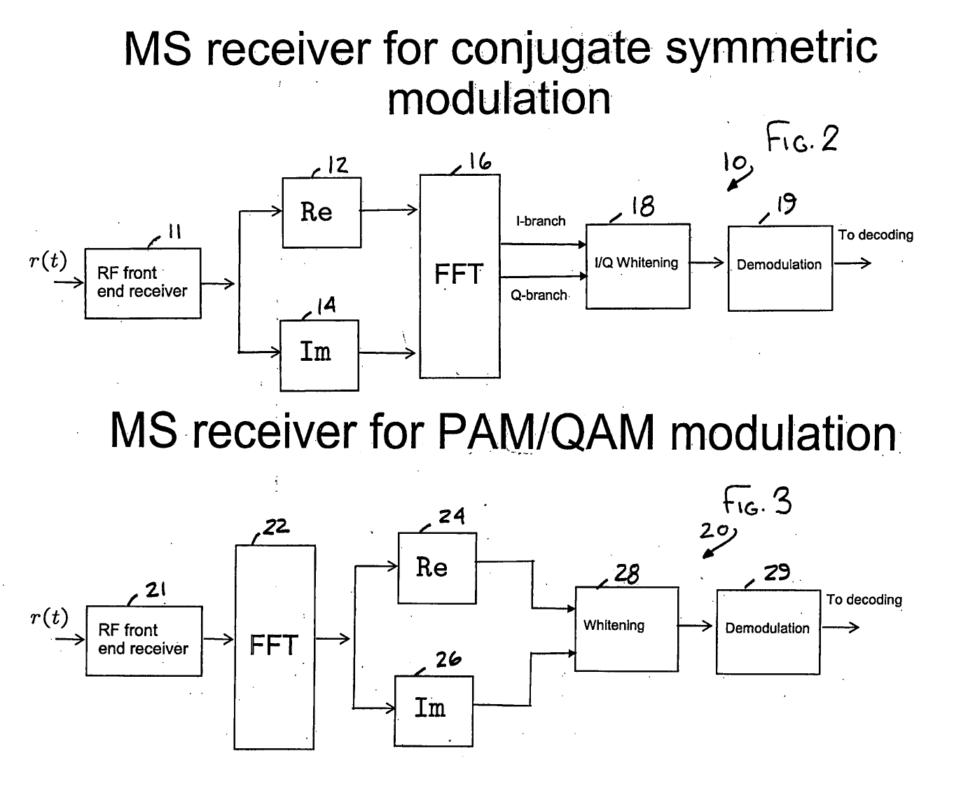

FIG. 1 depicts a flowchart illustrating one non-limiting example of a method for practicing the exemplary embodiments of this invention. In box 2, a multi-carrier signal is received. The received signal includes a plurality of subcarriers. In box 4, widely linear (WL) processing is performed on the received signal. The WL processing may be employed as further described above. Furthermore, the WL processing may be employed as described below with respect to FIGS. 2-5.

FIGS. 2, 3, 4 and 5 illustrate block diagrams of receiver architectures that may be used to practice the foregoing teachings.

FIG. 2 shows a MS receiver 10 for use with conjugate symmetric modulation, where Re represents a Real signal path 12 and Im represents an Imaginary signal path 14 that emanate from a multi-carrier RF receiver front end 11. A FFT block 16 receives the Re and Im signal paths 12 and 14, and outputs I and Q branch signals to an I/Q whitening filter 18, followed by a demodulator 19.

FIG. 3 shows a MS receiver 20 for use with PAM/QAM modulation, where an FFT block 22 receives a signal output from a multi-carrier RF front end 21, and that outputs a signal to both a Real signal path 24 and an Imaginary signal path 26, which are followed by a whitening filter 28 and a demodulator 29.

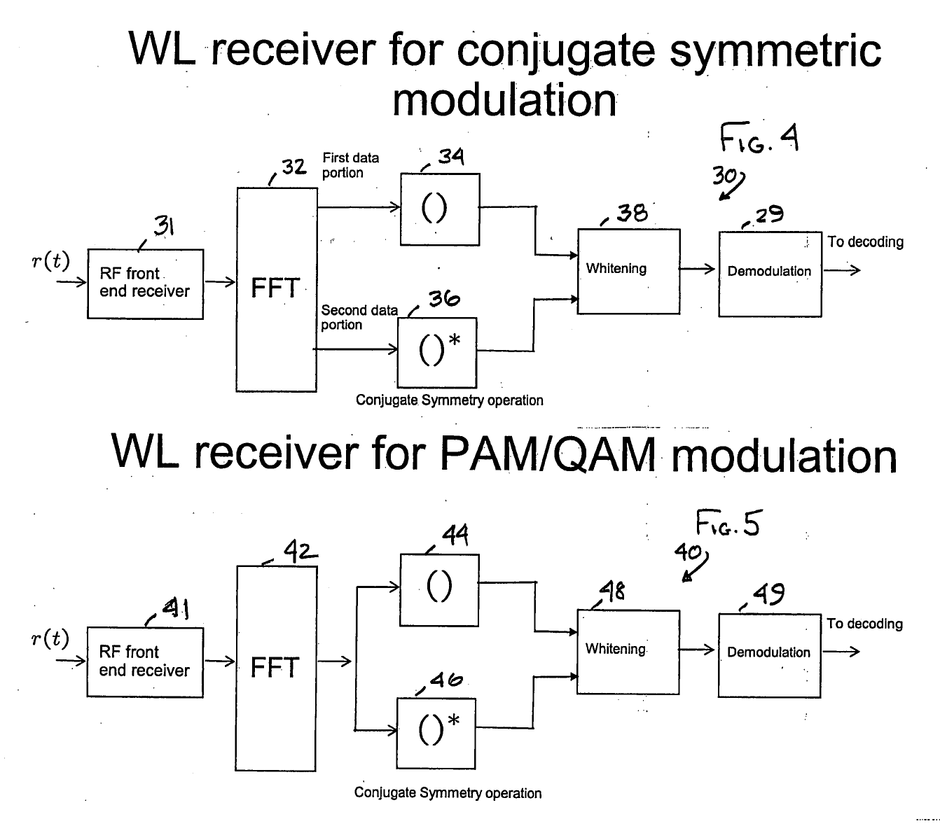

FIG. 4 shows a WL receiver 30 for use with conjugate symmetric modulation, where an FFT block 32 receives a signal output from a multi-carrier RF front end 31, and that outputs a first and a second data portion to blocks 34 and 36 that process the complex and complex-conjugate parts of the signal, respectively, and that thus execute the above-described conjugate symmetry operations. The blocks 34 and 36 provide outputs to a whitening filter 38, followed by a demodulator 39.

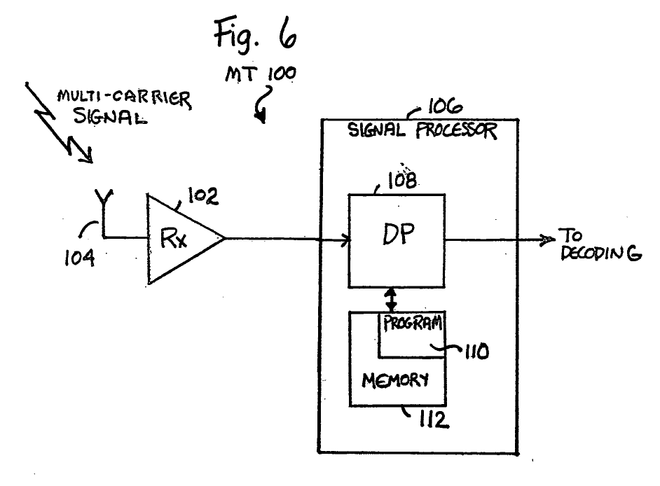

FIG. 5 shows a WL receiver 40 for use with PAM/QAM modulation, where an FFT block 42 receives a signal output from a multi-carrier RF front end 41, and that outputs a signal to both of the blocks 44 and 46 that execute the above-described conjugate symmetry operations. The blocks 44 and 46 provide outputs to a whitening filter 48, followed by a demodulator 49.

As illustrated above, the subcarriers preferentially are processed utilizing block processing, with resulting signals sent to a decoder in serial. However, other forms of processing (e.g. parallel, serial) may be employed in conjunction with the exemplary embodiments of the invention.

FIG. 6 is a block diagram of an electronic device, such as a mobile station or user equipment (UE) or mobile terminal (MT) 100, that can be used to implement the foregoing teachings. The MT 100 includes a multi-carrier RF receiver (Rx) 102 that receives a signal from a receive antenna 104. An output of the RF receiver 102 is provided to a signal processing block 106, that may include a data processor (DP) 108, such as a digital signal processor (DSP), that operates in conjunction with a program 110 stored in memory 112. Execution of the program 110 results in the MT 100 operating in accordance with one or more of the MS/WL reception modes discussed in detail above. The signal processing block 106 may also include a whitening filter, such as whiting filters 28, 38, 48 or 58 shown in FIGS. 2-5, and the demodulator, such as demodulators 29, 39, 49 or 59 also shown in FIGS. 2-5. One or both of these components may also be implemented in whole or in part by the data processor 108.

In general, the various embodiments of the MT 100 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by a data processor of the MT 100, such as the processor 108, or by hardware, or by a combination of software and hardware.

The memory 112 may be of any type suitable to the local technical environment and may be implemented using any suitable data storage technology, such as semiconductor-based memory devices, magnetic memory devices and systems, optical memory devices and systems, fixed memory and removable memory. The data processor 108 may be of any type suitable to the local technical environment, and may include one or more of general purpose computers, special purpose computers, microprocessors, DSPs and processors based on a multi-core processor architecture, as non-limiting examples.

10. Conclusion

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. For example, the exemplary embodiments of this invention may be utilized in a number of different types of multi-carrier or OFDM systems including, but not limited to, Ultra-Wideband (UWB), Wireless Local Area Network (WLAN), 802.16e, and 3.9 and fourth generation (4G) cellular systems. The 802.16e system is one being specified as an amendment to IEEE Standard 802.16 (“Air Interface for Fixed Broadband Wireless Access Systems”) as modified by IEEE Standards 802.16a and 802.16c. The 802.16e amendment covers “Physical and Medium Access Control Layers for Combined Fixed and Mobile Operation in Licensed Bands”.

The embodiments of this invention may also be realized by applying WL processing on the complex and complex-conjugate parts of the signal either before or after the DFT. One such alternative is mentioned above in the section that describes WL Combining. Similarly, the receiver embodiments discussed above in the sections entitled MS Processing for PAM OFDM and MS Processing for QAM OFDM can be realized in a complex and complex-conjugate form.

The embodiments of this invention may also be realized by implementing the noise whitening filter(s) 18, 28, 38, 48 as a pre-whitening filter using, for example, Choleski factorization of the noise correlation matrix.

However, all such modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
receiving a multi-carrier signal comprising a plurality of subcarriers; and
performing widely linear (WL) processing on the received signal.

2. The method of claim 1, wherein the multi-carrier signal comprises an orthogonal frequency division multiplexed (OFDM) signal.

3. The method of claim 1, wherein the received multi-carrier signal comprises a signal modulated using conjugate symmetric modulation.

4. The method of claim 3, wherein a time domain received signal in baseband form is denoted as:
yₖ=hₖ⊕sₖ+nₖ
and wherein in-phase and quadrature parts of the received signal are collected and stacked in vector format as:
$$[ \begin{matrix}ℜ {y}_{k} \\ 𝔍 {y}_{k}\end{matrix} ] = [ \begin{matrix}ℜ {h}_{k} \\ 𝔍 {h}_{k}\end{matrix} ] ⊗ {s}_{k} + [ \begin{matrix}ℜ {n}_{k} \\ 𝔍 {n}_{k}\end{matrix} ]$$
which has a vector form:
\tilde{y}ₖ=\tilde{h}ₖ⊕sₖ+ñₖ.

5. The method of claim 4, wherein a frequency domain received signal is denoted as:
\tilde{y}(fₖ)=\tilde{h}(fₖ)x(fₖ)+ñ(fₖ),
wherein elements of the denoted frequency domain received signal are complex valued and exhibit conjugate symmetry, wherein an information carrying symbols pair [x(fₖ),x*(N−fₖ)] is combined using an un-biased minimum mean-squared error (MMSE) scheme such that:
$$z ( {f}_{k} ) = \frac{1}{2} {\tilde{h}}^{†} ( {f}_{k} ) {R}_{\tilde{n} \tilde{n}}^{- 1} ( {f}_{k} ) [ \tilde{y} ( {f}_{k} ) + {\tilde{y}}^{*} ( N - {f}_{k} ) ] for k = 1 , … , \frac{N}{2} - 1$$
where MMSE weights are applied after combing conjugate symmetric parts.

6. The method of claim 3, wherein WL filtering is applied to complex and complex-conjugate replicas such that:
y̅(fₖ)= h̅(fₖ)x(fₖ)+ n̅(fₖ)
where
y̅(fₖ)≅[y(fₖ),y*(N−fₖ)]′, h̅(fₖ)≅[h(fₖ),h*(N−fₖ)]′, n̅(fₖ)≅[n(fₖ),n*(N−fₖ)]′.

7. The method of claim 6, wherein a conjugate symmetric symbol pair [x(fₖ), x*(N−fₖ)] is combined such that:
$$\overline{z} ( {f}_{k} ) = \frac{1}{2} {\tilde{h}}^{†} ( {f}_{k} ) {R}_{\tilde{n} \tilde{n}}^{- 1} ( {f}_{k} ) \overline{y} ( {f}_{k} ) for k = 1 , … , \frac{N}{2} - 1 ,$$
where R _{n̅ n̅}⁻¹(fₖ) denotes a WL noise correlation matrix and z̅(fₖ) denotes a scalar decision variable used to generate bit wise soft decisions.

8. The method of claim 1, wherein the received multi-carrier signal comprises a signal modulated using Pulse Amplitude Modulation (PAM).

9. The method of claim 8, wherein the WL processing comprises a Discrete Fourier Transform (DFT), wherein an output of the DFT comprises:
y(fₖ)=h(fₖ)a(fₖ)+n(fₖ),
wherein in-phase and quadrature parts of the received signal are collected such that:
$$[ \begin{matrix}ℜ y ( {f}_{k} ) \\ 𝔍 y ( {f}_{k} )\end{matrix} ] = [ \begin{matrix}ℜ h ( {f}_{k} ) \\ 𝔍 h ( {f}_{k} )\end{matrix} ] {s}_{k} + [ \begin{matrix}ℜ n ( {f}_{k} ) \\ 𝔍 n ( {f}_{k} )\end{matrix} ]$$
which has a compact vector form:
\check{y}(fₖ)=\check{h}(fₖ)a(fₖ)+\check{n}(fₖ).

10. The method of claim 9, wherein linear minimum mean squared error (LMMSE) symbol estimates are provided such that:
\check{z}(fₖ)=\check{h}†(fₖ)R_{\check{n}\check{n}}⁻¹(fₖ)\check{y}(fₖ).

11. The method of claim 1, wherein the received multi-carrier signal comprises a signal modulated using Quadrature Amplitude Modulation (QAM).

12. The method of claim 11, wherein the WL processing comprises a Discrete Fourier Transform (DFT), wherein a frequency domain output of the DFT comprises:
y(fₖ)=h(fₖ)b(fₖ)+n(fₖ),
wherein in-phase and quadrature parts of the received signal in a frequency domain are collected such that:
$$[ \begin{matrix}{y}_{I} ( {f}_{k} ) \\ {y}_{Q} ( {f}_{k} )\end{matrix} ] = [ \begin{matrix}{h}_{I} ( {f}_{k} ) & - {h}_{Q} ( {f}_{k} ) \\ {h}_{Q} ( {f}_{k} ) & {h}_{I} ( {f}_{k} )\end{matrix} ] [ \begin{matrix}{b}_{I} ( {f}_{k} ) \\ {b}_{Q} ( {f}_{k} )\end{matrix} ] + [ \begin{matrix}{n}_{I} ( {f}_{k} ) \\ {n}_{Q} ( {f}_{k} )\end{matrix} ]$$
which has a vector-matrix form:
y(fₖ)=H(fₖ)b(fₖ)+n(fₖ).

13. The method of claim 12, wherein QAM symbols are recovered using a ML/MAP decoder that minimizes a distance term, wherein the distance term comprises:
d(fₖ)=e(fₖ)Rₙₙ⁻¹(fₖ)e(fₖ),
wherein the candidate symbol e(fₖ) comprises:
e(fₖ)=y(fₖ)−H(fₖ)\hat{b}(fₖ)

14. The method of claim 1, wherein performing widely linear (WL) processing on the received signal comprises:
splitting the received signal into a real part and an imaginary part;
applying a Discrete Fourier Transform (DFT) to the real part and the imaginary part, wherein outputs of the DFT comprise an in-phase branch signal and a quadrature branch signal;
applying a whitening filter to the in-phase branch signal and the quadrature branch signal; and
demodulating an output of the whitening filter.

15. The method of claim 14, wherein the whitening filter comprises a pre-whitening filter utilizing Choleski factorization of a noise correlation matrix.

16. The method of claim 1, wherein performing widely linear (WL) processing on the received signal comprises:
applying a Discrete Fourier Transform (DFT) to the received signal;
splitting an output of the DFT into a real part and an imaginary part;
applying a whitening filter to the real part and the imaginary part; and
demodulating an output of the whitening filter.

17. The method of claim 1, wherein performing widely linear (WL) processing on the received signal comprises:
applying a Discrete Fourier Transform (DFT) to the received signal, wherein outputs of the DFT comprise a complex part of the signal and a complex-conjugate part of the signal;
applying a conjugate symmetry operation to the complex part and the complex-conjugate part;
applying a whitening filter to outputs of the conjugate symmetry operation; and
demodulating an output of the whitening filter.

18. The method of claim 1, wherein performing widely linear (WL) processing on the received signal comprises:
applying a Discrete Fourier Transform (DFT) to the received signal,
splitting an output of the DFT into a complex part of the signal and a complex-conjugate part of the signal;
applying a conjugate symmetry operation to the complex part and the complex-conjugate part;
applying a whitening filter to outputs of the conjugate symmetry operation; and
demodulating an output of the whitening filter.

19. The method of claim 1, wherein the multi-carrier signal comprises one of an Ultra-Wideband (UWB) signal or a Wireless Local Area Network (WLAN) signal.

20. A computer program product comprising program instructions embodied on a tangible computer-readable medium, execution of the program instructions resulting in operations comprising:
inputting a received multi-carrier signal comprising a plurality of subcarriers; and
performing widely linear (WL) processing on the received signal.

21. The computer program product of claim 20, wherein the multi-carrier signal comprises a signal modulated using conjugate symmetric modulation, wherein a time domain received signal in baseband form is denoted as:
yₖ=hₖ⊕sₖ+nₖ,
wherein in-phase and quadrature parts of the received signal are collected and stacked in vector format as:
$$[ \begin{matrix}ℜ {y}_{k} \\ 𝔍 {y}_{k}\end{matrix} ] = [ \begin{matrix}ℜ {h}_{k} \\ 𝔍 {h}_{k}\end{matrix} ] ⊗ {s}_{k} + [ \begin{matrix}ℜ {n}_{k} \\ 𝔍 {n}_{k}\end{matrix} ]$$
which has a vector form:
\tilde{y}ₖ=\tilde{h}ₖ⊕sₖ+ñₖ.

22. The computer program product of claim 21, wherein a frequency domain received signal is denoted as:
\tilde{y}(fₖ)=\tilde{h}(fₖ)x(fₖ)+ñ(fₖ),
wherein elements of the denoted frequency domain received signal are complex valued and exhibit conjugate symmetry, wherein an information carrying symbols pair [x(fₖ),x*(N−fₖ)] is combined using an un-biased minimum mean-squared error (MMSE) scheme such that:
$$z ( {f}_{k} ) = \frac{1}{2} {\tilde{h}}^{†} ( {f}_{k} ) {R}_{\tilde{n} \tilde{n}}^{- 1} ( {f}_{k} ) [ \tilde{y} ( {f}_{k} ) + {\tilde{y}}^{*} ( N - {f}_{k} ) ] for k = 1 , … , \frac{N}{2} - 1$$
where MMSE weights are applied after combing conjugate symmetric parts.

23. The computer program product of claim 20, wherein the multi-carrier signal comprises a signal modulated using conjugate symmetric modulation, wherein WL filtering is applied to complex and complex-conjugate replicas such that:
y̅(fₖ)= h̅(fₖ)x(fₖ)+ n̅(fₖ)
where
y̅(fₖ)≅[y(fₖ),y*(N−fₖ)]′, h̅(fₖ)≅[h(fₖ),h*(N−fₖ)]′, n̅(fₖ)≅[n(fₖ),n*(N−fₖ)]′.

24. The computer program product of claim 23, wherein a conjugate symmetric symbol pair [x(fₖ), x*(N−fₖ)] is combined such that:
$$\overline{z} ( {f}_{ k} ) = \frac{1}{ 2} { {h}^{ \_}}^{ †} ( {f}_{ k} ) {R}_{ {n}^{ \_} {n}^{ \_}}^{- 1} ( {f}_{ k} ) {y}^{ \_} ( {f}_{ k} ) for k = 1 , … , \frac{N}{ 2} - 1 ,$$
where R _{n̅ n̅}⁻¹(fₖ) denotes a WL noise correlation matrix and z̅(fₖ) denotes a scalar decision variable used to generate bit wise soft decisions.

25. The computer program product of claim 20, wherein the multi-carrier signal comprises a signal modulated using Pulse Amplitude Modulation (PAM), wherein the WL processing comprises a Discrete Fourier Transform (DFT), wherein an output of the DFT comprises:
y(fₖ)=h(fₖ)a(fₖ)+n(fₖ),
wherein in-phase and quadrature parts of the received signal are collected such that:
$$[ \begin{matrix}ℜ y ( {f}_{k} ) \\ 𝔍 y ( {f}_{k} )\end{matrix} ] = [ \begin{matrix}ℜ h ( {f}_{k} ) \\ 𝔍 h ( {f}_{k} )\end{matrix} ] {s}_{k} + [ \begin{matrix}ℜ n ( {f}_{k} ) \\ 𝔍 n ( {f}_{k} )\end{matrix} ]$$
which has a compact vector form:
\check{y}(fₖ)=\check{h}(fₖ)a(fₖ)+\check{n}(fₖ).

26. The computer program product of claim 25, wherein linear minimum mean squared error (LMMSE) symbol estimates are provided such that:
\check{z}(fₖ)=\check{h}†(fₖ)R_{\check{n}\check{n}}⁻¹(fₖ)\check{y}(fₖ).

27. The computer program product of claim 20, wherein the multi-carrier signal comprises a signal modulated using Quadrature Amplitude Modulation (QAM), wherein the WL processing comprises a Discrete Fourier Transform (DFT), wherein a frequency domain output of the DFT comprises:
y(fₖ)=h(fₖ)b(fₖ)+n(fₖ),
wherein in-phase and quadrature parts of the received signal in a frequency domain are collected such that:
$$[ \begin{matrix}{y}_{I} ( {f}_{k} ) \\ {y}_{Q} ( {f}_{k} )\end{matrix} ] = [ \begin{matrix}{h}_{I} ( {f}_{k} ) & - {h}_{Q} ( {f}_{k} ) \\ {h}_{Q} ( {f}_{k} ) & {h}_{I} ( {f}_{k} )\end{matrix} ] [ \begin{matrix}{b}_{I} ( {f}_{k} ) \\ {b}_{Q} ( {f}_{k} )\end{matrix} ] + [ \begin{matrix}{n}_{I} ( {f}_{k} ) \\ {n}_{Q} ( {f}_{k} )\end{matrix} ]$$
which has a vector-matrix form:
y(fₖ)=H(fₖ)b(fₖ)+n(fₖ).

28. The computer program product of claim 27, wherein QAM symbols are recovered using a ML/MAP decoder that minimizes a distance term, wherein the distance term comprises:
d(fₖ)=e(fₖ)Rₙₙ⁻¹(fₖ)e(fₖ),
wherein the candidate symbol e(fₖ) comprises:
e(fₖ)=y(fₖ)−H(fₖ)\hat{b}(fₖ).

29. An electronic device comprising:
a multi-carrier radio frequency receiver having an input for coupling to at least one antenna;
a signal processing block coupled to an output of the receiver, wherein the signal processing block comprises a widely linear (WL) signal processing unit operable to demodulate a received multi-carrier signal; and
a decoder having an input coupled to an output of the signal processing block.

30. The electronic device of claim 29, wherein the signal processing block comprises:
a Discrete Fourier Transform (DFT) having an input coupled to an output of the receiver;
a whitening filter having an input coupled to an output of the DFT; and
a demodulator having an input coupled to an output of the whitening filter and an output coupled to an input of the decoder.

31. The electronic device of claim 29, wherein the multi-carrier signal comprises a signal modulated using conjugate symmetric modulation, wherein a time domain received signal in baseband form is denoted as:
yₖ=hₖ⊕sₖ+nₖ,
wherein in-phase and quadrature parts of the received signal (are collected and stacked in vector format as:
$$[ \begin{matrix}ℜ {y}_{k} \\ 𝔍 {y}_{k}\end{matrix} ] = [ \begin{matrix}ℜ {h}_{k} \\ 𝔍 {h}_{k}\end{matrix} ] ⊗ {s}_{k} + [ \begin{matrix}ℜ {n}_{k} \\ 𝔍 {n}_{k}\end{matrix} ]$$
which has a vector form:
\tilde{y}ₖ=\tilde{h}ₖ⊕sₖ+ñₖ.

32. The electronic device of claim 29, wherein the multi-carrier signal comprises a signal modulated using Pulse Amplitude Modulation (PAM), wherein the WL signal processing unit comprises a Discrete Fourier Transform (DFT), wherein an output of the DFT comprises:
y(fₖ)=h(fₖ)a(fₖ)+n(fₖ),
wherein in-phase and quadrature parts of the received signal are collected such that:
$$[ \begin{matrix}ℜ y ( {f}_{k} ) \\ 𝔍 y ( {f}_{k} )\end{matrix} ] = [ \begin{matrix}ℜ h ( {f}_{k} ) \\ 𝔍 h ( {f}_{k} )\end{matrix} ] {s}_{k} + [ \begin{matrix}ℜ n ( {f}_{k} ) \\ 𝔍 n ( {f}_{k} )\end{matrix} ]$$
which has a compact vector form:
\check{y}(fₖ)=\check{h}(fₖ)a(fₖ)+\check{n}(fₖ).

33. The electronic device of claim 29, wherein the multi-carrier signal comprises a signal modulated using Quadrature Amplitude Modulation (QAM), wherein the WL signal processing unit comprises a Discrete Fourier Transform (DFT), wherein a frequency domain output of the DFT comprises:
y(fₖ)=h(fₖ)b(fₖ)+n(fₖ),
wherein in-phase and quadrature parts of the received signal in a frequency domain are collected such that:
$$[ \begin{matrix}{y}_{I} ( {f}_{k} ) \\ {y}_{Q} ( {f}_{k} )\end{matrix} ] = [ \begin{matrix}{h}_{I} ( {f}_{k} ) & - {h}_{Q} ( {f}_{k} ) \\ {h}_{Q} ( {f}_{k} ) & {h}_{I} ( {f}_{k} )\end{matrix} ] [ \begin{matrix}{b}_{I} ( {f}_{k} ) \\ {b}_{Q} ( {f}_{k} )\end{matrix} ] + [ \begin{matrix}{n}_{I} ( {f}_{k} ) \\ {n}_{Q} ( {f}_{k} )\end{matrix} ]$$
which has a vector-matrix form:
y(fₖ)=H(fₖ)b(fₖ)+n(fₖ).

34. An integrated circuit comprising
a multi-carrier radio frequency receiver having an input for coupling to at least one antenna;
a signal processing block coupled to an output of the receiver, wherein the signal processing block comprises a widely linear (WL) signal processing unit operable to demodulate a received multi-carrier signal; and
a decoder having an input coupled to an output of the signal processing block.

35. The integrated circuit of claim 34, wherein the signal processing block comprises:
a Discrete Fourier Transform (DFT) having an input coupled to an output of the receiver;
a whitening filter having an input coupled to an output of the DFT; and
a demodulator having an input coupled to an output of the whitening filter and an output coupled to an input of the decoder.
